(19) United States
(12) Patent Application Publication
(10) Pub. No.: US 2025/0177888 A1
(43) Pub. Date: Jun. 5, 2025

(54) SEPARATING DEVICE AND METHOD OF OPERATING A SEPARATING DEVICE

(71) Applicant: Sulzer Management AG, Winterthur (CH)

(72) Inventor: Martin HEDIN, Mariestad (SE)

(21) Appl. No.: 18/725,690

(22) PCT Filed: Jan. 16, 2023
(86) PCT No.: PCT/EP2023/050886

§ 371 Date: Jun. 28, 2024

(30) Foreign Application Priority Data
Jan. 19, 2022 (SE) 2250043-3

(51) Int. Cl. B01D 33/01; B01D 29/44; B01D 29/60; B01D 33/80; B01D 37/04; C02F 1/00; E02B 5/08; E02B 8/02

(52) U.S. Cl. CPC B01D 33/0166; B01D 29/445; B01D 29/605; B01D 33/807; B01D 37/045; C02F 1/001; C02F 1/008; C02F 2209/42; E02B 5/085; E02B 8/023

(57) ABSTRACT

A separating grid includes a separating unit arranged, when in use, in a position of inclination obliquely upwards in the direction of flow of running water, fixed grid bars, movable grid bars, and a drive unit connected to the movable grid bars to actuate the movable grid bars to interact with the solid particles and to draw the solid particles out of the running water and to carry the solid particles upwards along the fixed grid bars. A position detection device detects the top position or the bottom position of the movable grid bars. A water level detection device detects the water level of the running water. A control device controls the drive unit according to information from the position detection device regarding the position of the movable grid bars and information from the water level detection device regarding the water level.

### CROSS-REFERENCE TO RELATED APPLICATION

This application is a U.S. National Stage application of PCT/EP2023/050886, filed Jan. 16, 2023, which claims priority to Swedish Application No. 2250043-3, filed Jan. 19, 2022, the contents of each of which are hereby incorporated by reference.

### BACKGROUND

### Technical Field

The present disclosure relates to a device for separating solid particles from running water, removing solid particles present in running water, and a method of operating a device for removing solid particles present in running water.

### Background Information

The disclosure is in particular made for devices generally called separating grids known and widely used in incoming channels to municipal waste water treatment plants and process industries where separation of solid particles is required.

### SUMMARY

In the present disclosure, embodiments are referred to as a “device” as different wordings are used mean something having the same function as a separating grid. A separating unit is arranged in a position of inclination obliquely upwards, rearwards in a direction of flow of the water to be cleaned. Fixed and movable grid bars are arranged to transport solid particles, step by step, out of the water and to carry them upward along the fixed grid bars to an outlet, from which the solid objects are removed from the separating grid.

The movable grid bars are connected to a drive unit and arranged to, when actuated by the drive unit, draw solid particles step by step out of the water and to carry them upward along the fixed grid bars. During upward movement of the movable grid bars, the solid particles are moved upward with the movable grid bars. When the movable grid bars return to their lowest position, no transportation of the solid particles takes place.

An example of a prior art device for separating solid particles is disclosed in the patent publication EP 1 062 391 B2.

An object of the present disclosure is to provide a device, a separating grid, and a method of operating such a device, separating grid, which are more efficient than prior art solutions.

The disclosure is based on the insight that the operating cycle of the device can be optimized by detection of an operating position, increasing performance of the device and reducing energy consumption.

This object is achieved by a device according to the features and methods of operating a device disclosed herein.

According to a first aspect of the disclosure, a method of operating a device for the removing solid particles present in running water is provided, the device comprising: a separating unit arranged, when in use, in a position of inclination obliquely upwards in a direction of flow of the water, the separating unit comprising fixed grid bars and movable grid bars movable between a top position and a bottom position, a drive unit connected to the movable grid bars to actuate the movable grid bars to interact with the solid particles and draw the solid particles out of the water and to carry them upwards along the fixed grid bars, the method being characterized by the following steps: a) moving the movable grid bars upward for a predetermined upward time, b) detecting the position of the movable grid bars, c) if the movable grid bars are in the top position, moving the movable grid bars downward until in the bottom position, d) detecting the water level and if the water level is above a predetermined level, return to step a), e) pausing for a predetermined pause time and then return to step d).

In a preferred embodiment, step a) comprises a step of delaying operation a predetermined delay time before step moving the movable grid bars upward.

In a preferred embodiment, the upward time is between 0.2 and 1.0 seconds, and preferably for 0.3 seconds.

In a preferred embodiment, in the step of a) moving the movable grid bars upward for a predetermined upward time, the movable grid bars are moved a partial step in relation to the upward time.

According to a second aspect of the disclosure, a separating grid for removing solid particles present in running water is provided, the separating grid comprising: a separating unit arranged, when in use, in a position of inclination obliquely upwards in a direction of flow of the water, the separating grid comprising fixed grid bars and movable grid bars, a drive unit connected to the movable grid bars to actuate the movable grid bars to interact with the solid particles (4) and draw the solid particles out of the water and to carry them upwards along the fixed grid bars, the separating grid being characterized by a position detection device adapted to detect the position of the movable grid bars, a water level detection device for detecting a water level of the running water, and a control device for controlling the drive unit according to information from the position detection device regarding the position of the movable grid bars and information from the water level detection device regarding the water level, wherein the control device is adapted to perform the method steps according to the method according to the disclosure.

In a preferred embodiment, the position indicating device comprises a sensor for detecting the rotational position of a drive shaft comprised in the drive unit. The sensor is preferably an inductive sensor.

In a preferred embodiment, the device for handling and controlling the drive unit comprises on and off functions and a delay function.

### BRIEF DESCRIPTION OF THE DRAWINGS

Embodiments of the described, by way of example, with reference to the accompanying drawings, in which:

FIG. 1 illustrates a schematic perspective view of a separating grid according to the disclosure,

FIG. 2 illustrates a side view of the device of FIG. 1,

FIG. 3 illustrates an alternative embodiment of a separating grid,

FIG. 4 illustrates a detailed view of a drive unit comprised in a device according to the disclosure and

FIG. 5 illustrates a flow chart of the method according to the disclosure.

### DETAILED DESCRIPTION

In the following, a detailed description of a device and a method of operating such a device are given with reference to the accompanying drawings.

The device 1, having the function of a separating grid, is configured to be installed for example in a water purification plant. The purpose of the separating grid 1 is to collect and remove solid particles and objects 4 present in running water 2, such as sewage water, in a channel 3 made from concrete or the like. The particles and objects 4 are removed by a suitable device like a conveyor, away from the device for further treatment and/or deposition.

The separating grid 1 comprises a water detection device 2a detecting the water level in the channel 3. It is preferred that the water detection device 2a detects the water lever at the lowest part of the separating grid. The water detection device 2a can be anything suitable as level gauge that can send signals to control and regulate parts of the separating grid 1 when the water level has reached a predetermined level.

The separating grid 1 is designed as a frame structure constructed from frame profile sections, not shown in closer detail. Cover plates, such as side plates 5, an end-wall plate 6 and a bottom plate 7, are attached to the profile sections by fastening means (fastener/fastening device) such as screws and/or spot weld joints, not shown. The frame structure including the frame profile sections and the plates are preferably made from a non-corrosive material, such as stainless steel or some other material that is resistant to the effects of the water 2 and its contents. The side plates 5 form the lateral delimiting walls of the separating grid 1, whereas the end and bottom plates 6 and 7 delimit the upper rear wall and the upper bottom wall, respectively, of the separating grid 1.

Between the side plates 5, a separating unit 8 is provided, which assumes an obliquely upwards and rearwards tilted position, as seen in the direction of flow A of the running water 2. The separating unit 8 comprises juxtaposed fixed grid bars 9 and movable grid bars 10. There is a number of grid bars 9 and 10 to provide a suitable area for transportation of the solid particles and objects 4. The grid bars 9 and 10 are upended and preferably made from stainless steel or some other material of sufficient resistance in this connection.

The fixed grid bars 9 are non-movably attached to the separating grid 1 whereas the movable grid bars 10 are movably secured thereto, in a manner to be described in closer detail below. The number of fixed and movable grid bars 9, 10 can be varied according to the desired width of the separating grid 1.

The fixed as well as the movable grid bars 9, 10 are essentially straight as seen in their longitudinal extension and the bar edges turned towards the direction of flow A of the water are formed with collection and removal means (removal device) 11. These collection and removal means 11 are in the shape of depressions 12 and peaks 13 formed alternately in succession along essentially the entire length of the grid bars 9, 10, the depressions becoming deeper and the peaks higher and more pointed, as seen in the direction from the lower ends 14 of the grid bars 9, 10 to their upper ends 15. As appears from the drawings, the depressions 12 and the peaks 13 therefore are comparatively shallow and low, respectively, at the lower ends 14 of the grid bars 9, 10, in which area their configuration resembles that of small waves and become increasingly more pronounced in the direction towards the upper grid bar ends 15, in which area they have a step-like configuration.

When actuated by a drive unit 16, to be described in more detail further on, the movable grid bars 10 of the above-described collection and removal means 11 serve the purpose of carrying the solid particles and objects 4 step by step upwards, out of the running water 2 and along the corresponding collection and removal means 11 of the fixed grid bars 9, up to a discharge means (discharger/discharge device) or outlet 17 positioned on the upper end of the separating grid, upstream from the upper ends 15 of the grid bars 9, 10. From this outlet 17, the particles and objects 4 are removed via a suitable device, conveyor or the like, not shown in more detail, for further treatment/processing and/or use/deposition.

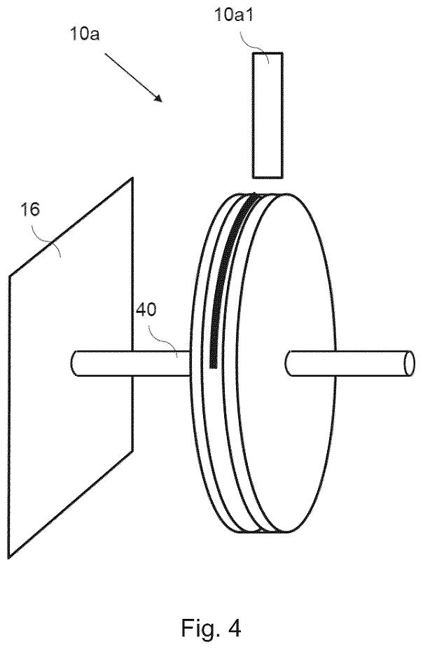

A position detection device 10a for indicating the position of the movable grid bars 10 is comprised in the separating grid 1, see FIG. 4. The position detection device 10a comprises a sensor 10a1 detecting the rotational position of a drive shaft 40 comprised in the drive unit 16. The sensor 10al is preferably an inductive sensor. By detecting the rotational position of the drive shaft 40, the position of the movable grid bars 10 is indirectly detected.

A control device 16a for controlling the drive unit 16 is comprised in the separating grid 1. According to the information from the water detection device 2a and according to the information from the position detection device 10a regarding the position of the movable grid bars 10, the drive unit 16 is actuated. The control device 16a for controlling the drive unit 16 comprises on and off functions and a delay function.

The movable grid bars 10 are connected in the area of their upper part 18 to the drive unit 16 and in the area of their lower part 19 they are suspended in the lower part 20 of the separating grid 1 by a cradle 21. The movable grid bars 10 are removably mounted in the region of their upper part 18 on two upper movable cross beams 22. The cross beams 22 extend crosswise relative to the separating grid 1 underneath the side plates 5 and they are connected to the drive unit 16 in a manner to be described in more detail further on. In the area of their lower part the movable grid bars 10 are similarly removably mounted on two lower movable cross beams 23. These cross beams 23 are essentially similar to the upper cross beams 22 and like them they extend crosswise relative to the separating grid 1 underneath the side plates 5. In a manner also to be described in more detail further on, the lower cross bars 23 are connected to the cradle 21.

The fixed grid bars 9 are removably mounted between their ends 14, 15 on spaced apart, stationary cross beams 24, in the present case on four such cross beams. These cross beams extend crosswise relative to the separating grid 1 below the side plates 5 while at the same time forming part of the frame structure of the separating grid 1.

The cradle 21 is fitted with suspension units 25, one at each side of the separating unit 8. More precisely, the two suspension units 25 of the cradle 21 are placed in a protected position on the external faces 26 of the side plates 5 that are turned outwards, away from the separating unit.

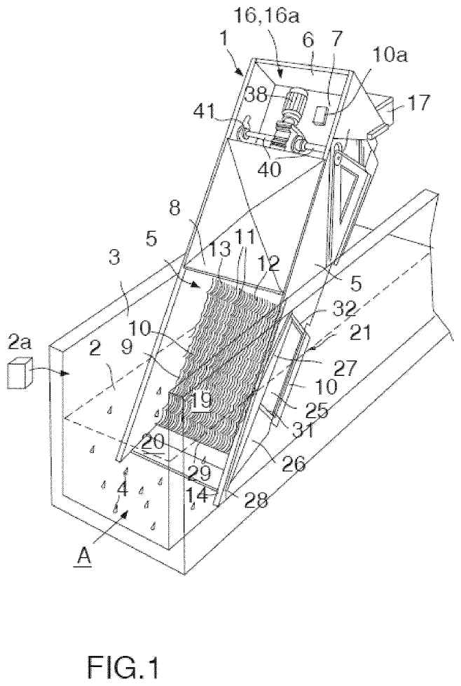

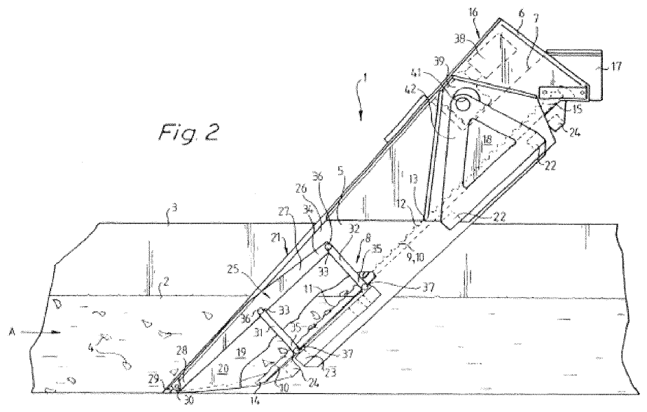

In accordance with the embodiment of FIGS. 1 and 2, each suspension unit 25 comprises an elongate rocker arm 27 extending in the longitudinal direction of the separating unit 8, essentially in parallel with and vertically spaced from the movable-grid bars 10, as most clearly apparent from FIG. 2. At the lower rocker arm ends 28, submerged into the running water 2, pivots 30 pivotally connect the rocker arms 27 to the lower end 29, likewise submerged in the water 2, of the separating grid 1.

In accordance with the embodiment of FIGS. 1 and 2, each suspension unit 25 comprises two rocker links 31 and 32. These extend in an essentially spaced apart, inter-parallel relationship essentially at right angles to the rocker arm 27 and to the movable grid bars 10. At one of their ends, the upper ends 33, the two rocker links 31, 32 are articulated to the rocker arm 27 at a point intermediate the lower end 28 and the upper end 34 thereof, and at the opposite, lower rocker link ends 35, pivots 36 and 37 connect the links to the movable grid bars 10.

The two suspension units 25 of the cradle 21, consisting of the rocker arms 27 and the rocker links 31, 32 and their associated pivots 30, 36, 37, are made from a material that is suitable for their intended purpose, preferably like the rest of the separating grid 1 from stainless steel or the like. The pivots 30, 36 and 37 could consist of slide and/or roller bearings of suitable configuration and can be permanently lubricated and/or encapsulated to resist the environmental conditions of the water 2.

More precisely, one of the rocker links 31, 32, in the present case rocker link 32, is pivotally connected at one of its ends, the upper end 33, to the rocker arm 27, essentially in the area of the upper rocker arm end 34, and at its lower end 35 to the movable grid bars 10 essentially in the area of the lower one-third of the bars as calculated from the lower bar ends 14. The other rocker link 31 is pivotally connected at one of its ends, the upper end 33, to the rocker arm 27, the point of connection essentially located in the area halfway between the upper and lower ends 28, 34 of said arm, whereas at its opposite lower end 35 said link is pivotally connected to the movable grid bars 10, essentially in the area of the lower grid bar ends 14. The above-defined location of the pivot points interconnecting the rocker arms 27, the rocker links 31, 32, and the grid bars 10 is but one of several possible examples and could of course be varied.

In accordance with the shown embodiment, the two suspension units 25 consisting of the rocker arms 27 and the rocker links 31, 32 are directly or indirectly interconnected by the two lower movable cross beams 23, on which the movable grid bars 10 are mounted in the area of their lower part 19.

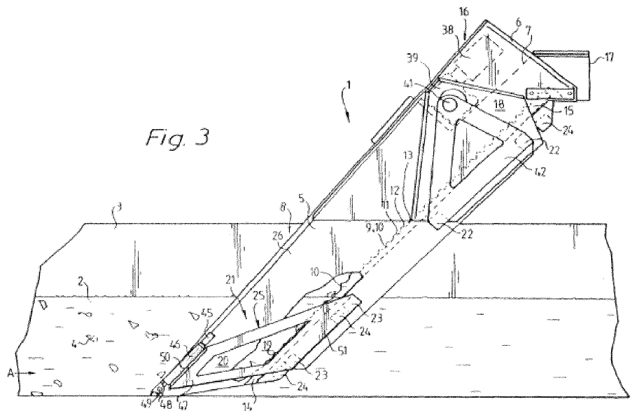

In accordance with the second preferred embodiment illustrated in FIG. 3 each suspension unit 25 comprises three main components, viz. a rod member 45, a tubular member 47 and a transmission means (transmitter/transmission device) 47.

The rod member 45 preferably is configured as a cylindrical piston rod the lower end of which. 48, which is submerged in the running water 2, is pivotally connected to the lower end 29 of the separating grid 1 by a pivot 49.

For adaptation to the configuration of the rod member 45, the tubular member 46 preferably is in the form of a bushing which is mounted on the piston rod for concentric sliding movement thereon in any suitable manner allowing it to be displaced longitudinally to and from along the piston rod.

The rod and tubular members 45, 46, like the rocker arm 27 in accordance with the embodiment of FIGS. 1 and 2, extend in the longitudinal direction of the separating unit 8, see FIG. 3, essentially in parallel with the movable grid bars 10 and spaced above the latter.

The third main component of the suspension unit 25 in accordance with FIG. 3, viz. transmission means 47, is fixedly connected between the tubular member 46 and the movable grid bars 10. More precisely, the transmission means 47 in this case is configured essentially as an upright trapezoid and extends essentially vertically and obliquely, say at an angle of 45-60°, to on the one hand the bearing unit formed by the rod and tubular members 45, 46 and on the other to the movable grid bars 10. The two opposite parallel sides 50, 51 of the transmission means 47 preferably are fixedly secured to the tubular member 46 and the movable grid bars 10, respectively, in any suitable manner, such as by welding, riveting, bolting etcetera.

The shape and inclination of the transmission means 47 as described above are not the only possible ones. The essential feature is that it operates as a moment-resisting and rigid transmission element between the bearing unit formed by the rod and tubular members 45, 46 and the movable grid bars 10.

Also in accordance with the embodiment of FIG. 3, the components of the two suspension units 25 of the cradle 21, consisting of the rod and tubular members 45, 46 and the transmission including their means 47 associated connecting means (connector/connecting device), naturally are made from a material that is well suited for their intended application, preferably from stainless steel or the like. Also in this case the joints 49 can be made from slide and/or roller bearings, and the bearing units formed by the rod and tubular members 45, 46 can be configured in a corresponding manner or as linear ball bearings etcetera. Irrespective of the bearing type, the bearings can be of a permanent-lubricated type and/or be encapsulated in order to resist the severe environmental conditions in the running water 2.

In order to produce the motion of the movable grid bars 10, the drive unit 16 comprises an electric drive motor 38, which is mounted on the frame structure of the separating grid 1, at the upper part thereof. A gear box 39 having two coaxial and oppositely directed drive shafts 40 is mounted on the motor 38. The drive shafts are rotationally mounted in bearings 41 on the side plates 5 and extend through these plates. Externally of the side plates 5, each drive shaft 40 actuates its respective one of two identical eccentric mechanisms 41. Each eccentric mechanism 41 is coupled to a transmission means (transmitter/transmission device) 42 of essentially triangular configuration made from sheet metal or other suitable material, preferably stainless steel or the like. In turn, the transmission means 42 are connected to the two upper movable cross beams 22 on which the movable grid bars 10 are mounted in the area of their upper part 18.

In this manner the movable grid bars 10 are actuated, and in turn these grid bars set the two suspension units 25 in motion. The sought-after step by step conveyance of the solid particles and objects 4 up to the outlet 17 is thus achieved.

The improved operation of the separating grid 1 will now be described in detail. The position detection device 10a and the water detection device 2a in combination give the possibility to control and regulate the movement of the movable grid bars 10 by the use of the drive unit 16 in a way that will be regulated depending on the present parameters and the present need. That optimizes the device and makes the device work more efficiently and timesaving and improves the removal of solid particles from the water. Stop and blocking time will be lowered, the wear of the device is lowered. The grid area will be better designed, and the separation will be improved. The device is more efficient than prior art solutions.

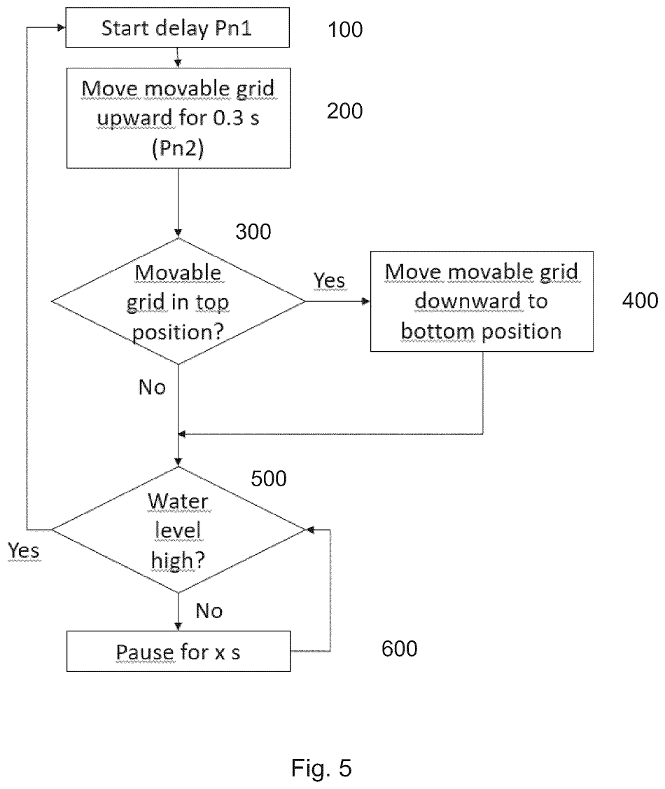

The method of operating the separating grid 1 will now be described with reference to the flow chart of FIG. 5. First, in a step 100 there is an optional start delay Pn1 of for example 0.5 seconds. Then, in a step 200, the movable grid 10 is moved upward for a predetermined upward time Pn2, preferably for a time of between 0.2 and 1.0 seconds, such as 0.3 seconds. This upward movement constitutes a partial step in relation to the upward time. The bar typically make 5-12 upward movements (partial steps) before it reaches the top position, and one whole step in the downward movement. Efficiency is hereby increased since upward movement time is significantly longer than the downward movement time.

Separation of solids size is in relation to the partial step length, means that separation of smaller solids can be separated by a shorter step length. During this upward movement, the solid particles and objects 4 are moved upwards by the movable grid 10, as explained above. After each step 200, it is checked whether the movable grid 10 is in its top position. This check is performed by the position detection device 10a. If it is found that the movable grid 10 is in its top position, operation is continued by moving without any interruption the movable grid 10 downward to its bottom position. The time it takes to move the movable grid 10 from its top position to its bottom position depends on the motor speed and gear ratio, but can typically be between two and three seconds, such as 2.3 seconds.

If in step 300 it is found that the movable grid 10 is not in its top position or after the movement of the movable grid 10 to its bottom position, as the case can be, the water level is checked in a step 500. The water level is checked by the water detection device 2a and if it is found that it is below a predetermined level, operation is paused in a step 600 for a predetermined time, such as 0.1-2.5 seconds. After the pause, the water level is checked again and this continues until it is determined that the water level has risen above the predetermined water level. The operation then reverts to the optional delay Pn1 in step 100 and the above described operation is repeated.

Preferred embodiments of a separating grid and a method of operating this separating grid according to the disclosure have been described and illustrated herein. However, the disclosure must not be regarded as restricted to these embodiments but could be varied in many ways within the scope of the claimed protection as defined in the appended claims.

1. A method of operating a device for the removing solid particles present in running water, the device comprising
a separating unit arranged, when in use, in a position of inclination obliquely upwards in a direction of flow of the running water, the separating unit comprising fixed grid bars and movable grid bars movable between a top position and a bottom position,
a drive unit connected to the movable grid bars to actuate the movable grid bars to interact with the solid particles and to draw the solid particles out of the water and to carry the solid particles upwards along the fixed grid bars,
the method comprising:
moving the movable grid bars upward for a predetermined upward time;
detecting at least one of the top position and the bottom position of the movable grid bars,
when the movable grid bars are in the top position, moving the movable grid bars downward until in the bottom position;
detecting a water level of the running water and when the water level is above a predetermined level, return to moving the movable grid bars upward for the predetermined upward time; and
pausing for a predetermined pause time and then return to detecting the water level and when the water level is above the predetermined level, return to moving the movable grid bars upward for the predetermined upward time.

2. The method according to claim 1, wherein the moving the movable grid bars upward for a predetermined upward time comprises delaying operation for a predetermined delay time before the moving of the movable grid bars upward.

3. The method according to claim 1, wherein the predetermined upward time is between 0.2 and 1.0 seconds.

4. The method according to claim 1, wherein, in moving the movable grid bars upward for the predetermined upward time, includes moving the movable grid bars a partial step in relation to the predetermined upward time.

5. A separating grid for removing solid particles present in running water, comprising:
the separating unit arranged, when in use, in the position of inclination obliquely upwards in the direction of flow of the running water;
the fixed grid bars;
the movable grid bars;
the drive unit connected to the movable grid bars to actuate the movable grid bars to interact with the solid particles and to draw the solid particles out of the running water and to carry the solid particles upwards along the fixed grid bars;
a position detection device configured to detect at least one of the top position and the bottom position of the movable grid bars;
a water level detection device configured to detect the water level of the running water; and
a control device configured to control the drive unit according to information from the position detection device regarding the position of the movable grid bars and information from the water level detection device regarding the water level, the control device configured to perform the method according to claim 1.

6. The separating grid according to claim 5, wherein the position indicating device comprises a sensor to detect a rotational position of a drive shaft comprised in the drive unit.

7. The separating grid according to claim 6, wherein the sensor is an inductive sensor.

8. The separating grid according to claim 5, further comprising device for handling and controlling the drive unit comprising on and off functions and a delay function.

9. The method according to claim 1, wherein the predetermined upward time is 0.3 seconds.

10. The method according to claim 2, wherein the predetermined upward time is between 0.2 and 1.0 seconds.

11. The method according to claim 2, wherein, in the moving the movable grid bars upward for the predetermined upward time, includes moving the movable grid bars a partial step in relation to the predetermined upward time.

12. The method according to claim 3, wherein, in the moving the movable grid bars upward for the predetermined upward time, includes moving the movable grid bars a partial step in relation to the predetermined upward time.

13. The separating grid according to claim 6, further comprising a device for handling and controlling the drive unit comprising on and off functions and a delay function.

14. The separating grid according to claim 7, further comprising a device for handling and controlling the drive unit comprising on and off functions and a delay function.
